(19) United States
(12) Patent Application Publication
(10) Pub. No.: US 2026/0059345 A1
(43) Pub. Date: Feb. 26, 2026

(54) TRIANGLE OF INTEREST SIGNAL TRANSMISSION OPTIMIZATION SYSTEM AND METHOD

(71) Applicant: DISH Wireless L.L.C., Englewood, CO (US)

(72) Inventors: Ahmed Awwad Whdan, Centennial, CO (US); Satish Kumar Sharma, Denver, CO (US); Arnold Foronda Agcaoili, Littleton, CO (US); Shashank Avvaru, Littleton, CO (US)

(21) Appl. No.: 18/815,718

(22) Filed: Aug. 26, 2024

(51) Int. Cl. H04W 16/30; H04W 16/18

(52) U.S. Cl. CPC H04W 16/30; H04W 16/18

(57) ABSTRACT

Embodiments are directed towards systems and methods for determining signal transmission optimization of coverage regions. The method includes: creating a grid layout over a geographical area of coverage regions, the layout including a plurality of coverage region grids with associated cellular transmission data sets; applying a coverage region algorithm to analyze the cellular transmission data sets; prioritizing the plurality of coverage region grids for cellular site deployment; analyzing technological impacts on the geographical area of the prioritization of the plurality of coverage region grids; filtering the plurality of coverage region grids based on criteria set for each category; and prioritizing the plurality of coverage region grids for cellular site deployment.

### BACKGROUND

As the use of smart phones and Internet of Things (IoT) devices has increased, so too has the desire for more reliable, fast, and continuous transmission of content. In an effort to improve the content transmission, networks continue to improve with faster speeds and increased bandwidth. The advent and implementation of advanced wireless technology has resulted in faster speeds and increased bandwidth. Thus, minimizing interruptions in the supporting networking infrastructure is important to providing a resilient and stable network with the desired end-to-end performance. It is with respect to these and other considerations that the embodiments described herein have been made.

In some types of cellular network systems, there may be issues with problematic service coverage. This may be due to the network service area being new or may be because of long-term issues such as geography or weather conditions. There is a continuing need to address these network service areas with problematic service coverage with some type of technological improvement that will overcome these service coverage shortfalls. Unfortunately, a full solution to these end user experience problems of dropped calls and other types of poor network coverage has yet to be produced. The present disclosure addresses this and other issues.

### BRIEF SUMMARY

The present disclosure relates generally to telecommunication networks and, more particularly, to a system and method for determining signal transmission optimization of coverage regions. Specifically, the present disclosure is directed to a system and method that analyze data and prioritize cellular site deployment. Additionally, the disclosed system and method provide a precise assessment of the impact of each added cellular site deployment.

Briefly stated, one or more methods for determining signal transmission optimization of coverage regions are described. Some such methods include: creating a grid layout over a geographical area of coverage regions, the layout including a plurality of coverage region grids for potential cellular site deployment; intersecting the plurality of coverage region grids with cellular transmission data sets; applying a coverage region algorithm to analyze the cellular transmission data sets; converting the analysis into numerical metrics; analyzing technological impacts on the geographical area of the plurality of coverage region grids based on the numerical metrics; filtering the plurality of coverage region grids based on criteria set for each category; and prioritizing the plurality of coverage region grids for cellular site deployment.

In some embodiments of the method for determining signal transmission optimization of coverage regions, the coverage region algorithm divides the geography into triangles in vector format for assessment and prioritization. In another aspect of some embodiments, new sites are located within a triangle formed by three existing sites. In still another aspect of some embodiments, each coverage region is uniquely identified and the data sets within the coverage region are analyzed for ranking. In yet another aspect of some embodiments, if a coverage region has a large technological impact based on factors such as population, stores, capacity, Points of Interest (POI), and the like, the coverage region receives higher priority.

In one or more embodiments, the method for determining signal transmission optimization of coverage regions, further includes: creating a search ring within a coverage region centroid of the highest priority of grid within the plurality of coverage region grids. In another aspect of some embodiments, the cellular transmission data sets include one or more of population density, capacity data, proximity to highest traffic sites, average Inter-site distance (ISD) per cluster, ISD of site/Add On to Launch site, customer experience drop percentage, Drop Call Volume, and Drop Call Rate. In still another aspect of some embodiments, the method further includes: updating the ranking of the cellular transmission data sets. In yet another aspect of some embodiments, the method further includes: proposing a new cellular site location for deployment.

In other embodiments, one or more systems for determining signal transmission optimization of coverage regions are described. The system includes a memory that stores computer-executable instructions; and a processor that executes the computer-executable instructions that cause the processor to: create a grid layout over a geographical area of coverage regions, the layout including a plurality of coverage region grids for potential cellular site deployment; intersect the plurality of coverage region grids with cellular transmission data sets; apply a coverage region algorithm to analyze the cellular transmission data sets; convert the analysis into numerical metrics; analyze technological impacts on the geographical area of the plurality of coverage region grids based on the numerical metrics; filtering the plurality of coverage region grids based on criteria set for each category; and prioritize the plurality of coverage region grids for cellular site deployment.

In some embodiments of the system for determining signal transmission optimization of coverage regions, the coverage region algorithm divides the geography into triangles in vector format for assessment and prioritization. In another aspect of some embodiments, new sites are located within a triangle formed by three existing sites. In still another aspect of some embodiments, each coverage region is uniquely identified and the data sets within the coverage region are analyzed for ranking. In yet another aspect of some embodiments, if a coverage region demonstrates high impact based on factors such as population, stores, capacity, Points of Interest (POI), and the like, the coverage region receives higher priority.

In one or more embodiments of the system for determining signal transmission optimization of coverage regions, a search ring is created within a coverage region centroid of the highest priority of grid within the plurality of coverage region grids. In another aspect of some embodiments, the cellular transmission data sets include one or more of population density, capacity data, proximity to highest traffic sites, average Inter-site distance (ISD) per cluster, ISD of site/Add On to Launch site, customer experience drop percentage, Drop Call Volume, and Drop Call Rate. In another aspect of some embodiments, the ranking of the cellular transmission data sets are updated.

In other embodiments of the method for determining signal transmission optimization of coverage regions, such methods include: creating grid layout over a geographical area of coverage regions, the layout including a plurality of coverage region grids for potential cellular site deployment with associated cellular transmission data sets; applying a coverage region algorithm to analyze the cellular transmission data sets; analyzing technological impacts on the geographical area of the prioritization of the plurality of coverage region grids; filtering the plurality of coverage region grids based on criteria set for each category; and prioritizing the plurality of coverage region grids for cellular site deployment.

In some embodiments, the method for determining signal transmission optimization of coverage regions further includes converting the analysis into numerical metrics. In one aspect of some embodiments, the coverage region algorithm divides the geography into triangles in vector format for assessment and prioritization. In another aspect of some embodiments, new sites are located within a triangle formed by three existing sites. In still another aspect of some embodiments, each coverage region is uniquely identified, and the data sets within the coverage region are analyzed for ranking. In yet another aspect of some embodiments, if a coverage region demonstrates high impact based on factors such as population, stores, capacity, Points of Interest (POI), and the like, the coverage region receives higher priority.

In one or more embodiments, the method for determining signal transmission optimization of coverage regions, further includes: creating a search ring within a triangle centroid of the highest priority of grid within the plurality of coverage region grids. In another aspect of some embodiments, the cellular transmission data sets include one or more of population density, capacity data, proximity to highest traffic sites, average Inter-site distance (ISD) per cluster, ISD of site/Add On to Launch site, customer experience drop percentage, Drop Call Volume, and Drop Call Rate. In still another aspect of some embodiments, the method further includes: updating the ranking of the cellular transmission data sets. In yet another aspect of some embodiments, the method further includes: proposing a new cellular site location for deployment.

### BRIEF DESCRIPTION OF THE DRAWINGS

The patent or application filed contains at least one drawing executed in color. Copies of this patent or patent application publication with color drawing(s) will be provided by the Office upon request and payment of the necessary fee.

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings:

FIG. 1 illustrates a context diagram of an environment in which a system for determining signal transmission optimization of coverage regions may be implemented in accordance with embodiments described herein.

FIG. 2 illustrates a diagram of a series of coverage regions and search ring architecture in the environment of FIG. 1, which may be implemented in accordance with embodiments described herein.

FIG. 3 illustrates a diagram showing a single coverage region and search ring architecture.

FIG. 4 illustrates a coverage region with technological objectives that may be ranked with customization.

FIG. 5 illustrates a population density priority analysis using coverage regions.

FIG. 6 illustrates a competition priority analysis using coverage regions and the number of competitor's sites.

FIG. 7 illustrates a traffic per store priority analysis using coverage regions.

FIG. 8 illustrates a customer drop call priority analysis using coverage regions.

FIG. 9 illustrates a capacity limitation break priority analysis using coverage regions.

FIG. 10 illustrates a customer experience drop rate percentage analysis using coverage regions.

FIG. 11 is a logic diagram in a determining signal transmission optimization of coverage regions analysis.

FIG. 12 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Advanced cellular networks provide a broad range of wireless services delivered to the end user across multiple access platforms and multi-layer networks. These 5G networks employ a configuration of cellular sites to interconnect the network. Determining an optimized sequence and pattern to deploy the cellular sites in the 5G network is an important factor for network efficiency and deployment success. A system for determining signal transmission optimization also facilitates such efficiencies in cellular network site deployment.

For example, 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible, and virtual RAN with interfaces creating additional data access points. 5G network functions may be completely software-based and designed as cloud-native, meaning that they're agnostic to the underlying cloud infrastructure, allowing higher deployment agility and flexibility. With the advent of 5G, industry experts defined how the 5G Core (5GC) network should evolve to support the needs of 5G New Radio (NR) and the advanced use cases enabled by it. The 3rd Generation Partnership Project (3GPP) develops protocols and standards for telecommunication technologies including RAN and core transport networks and service capabilities. 3GPP has provided complete system specifications for 5G network architecture which is much more service oriented than previous generations. Future network architectures, such as 6G and others, are expected to utilize many of these features and functionalities.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them. This MEC technology is not exclusive to 5G, but is certainly important to its efficiency. Characteristics of the MEC include the low latency, high bandwidth, and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices inherent to 5G deployment and the rise of IoT.

The 3rd Generation Partnership Project (3GPP) develops protocols for mobile telecommunications and has developed a standard for 5G. The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open-source development, ultimately to ease the deployment of new features and technology with scale. The O-RAN ALLIANCE objective is to allow multi-vendor deployment with off-the-shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises a set of radio base stations (each known as Next Generation Node B (gNB)) connected to the 5G Core (5GC) and to each other. The gNB incorporates three main functional modules: the Centralized Unit (CU), the Distributed Unit (DU), and the Radio Unit (RU), which can be deployed in multiple combinations. The primary interface is referred to as the F1 interface between DU and CU and is interoperable across vendors. The CU may be further disaggregated into the CU user plane (CU-UP) and CU control plane (CU-CP), both of which connect to the DU over F1-U and F1-C interfaces respectively. This 5G RAN architecture is described in 3GPP TS 38.401 V16.8.0 (2021-12). Each network function (NF) is formed by a combination of small pieces of software code called microservices. Future network architectures, such as 6G and others, are expected to utilize many of these technological improvements, plus additional advancements.

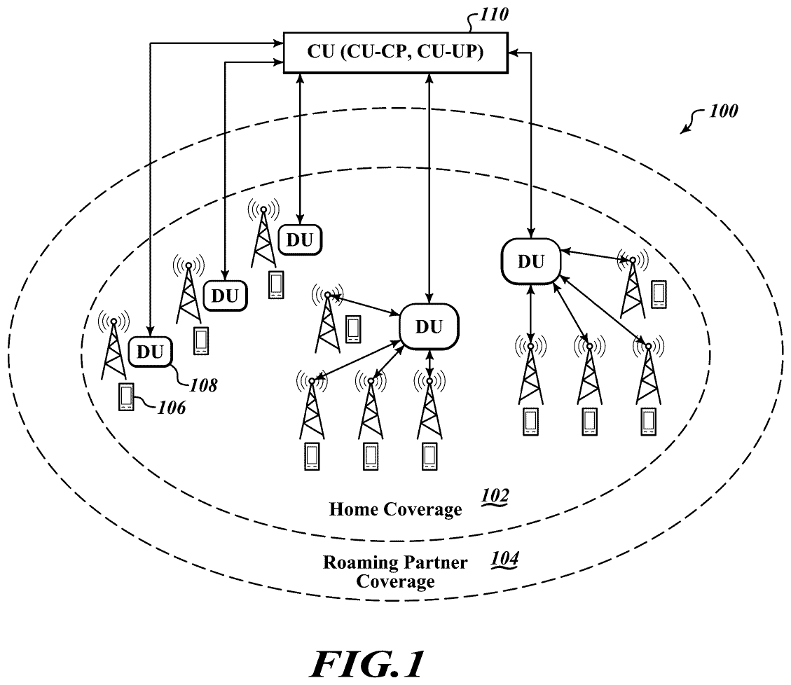

FIG. 1 illustrates a context diagram of an environment in which a system for determining signal transmission optimization of coverage regions may be implemented in accordance with embodiments described herein. A given area 100 will mostly be covered by two or more mobile network operators' wireless networks. Generally, mobile network operators have some roaming agreements that allow users to roam from home network to partner network under certain conditions, shown in FIG. 1 as home coverage area 102 and roaming partner coverage area 104. Operators may configure the mobile user's device, referred to herein as user equipment (UE), such as UE 106, with priority and a designated roaming partner network that is used in the roaming partner network coverage area 104. If a UE (e.g., UE 106) cannot find the home network coverage area 102, the UE will be transferred to a partner roaming network in the roaming partner coverage area 104. Thus, service coverage is maintained even if the home coverage area 102 is providing unsatisfactory service coverage.

As shown in FIG. 1, a 5G RAN is split into DUs (e.g., DU 108) that manage scheduling of all the users and a CU that manages the mobility and radio resource control (RRC) state for all the UEs. The RRC is a layer within the 5G NR protocol stack. It exists only in the control plane, in the UE and in the gNB. The behavior and functions of RRC are governed by the current state of RRC. In 5G NR, RRC has three distinct states: RRC_IDLE, RRC_CONNECTED and RRC_INACTIVE.

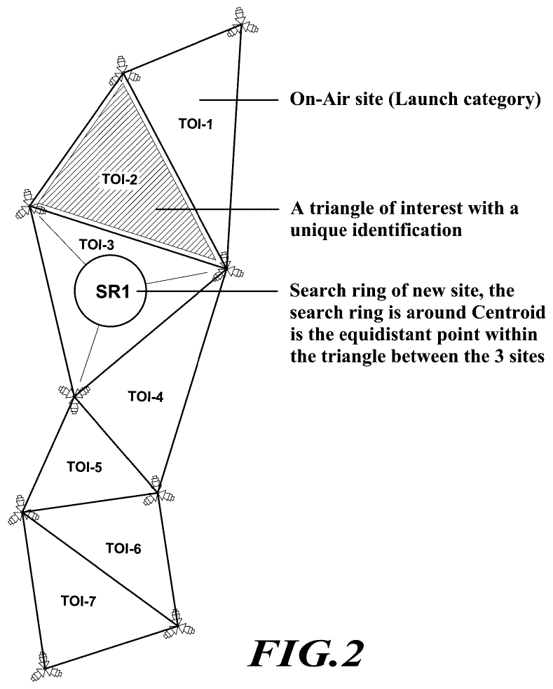

Referring now to FIG. 2, a series of coverage regions and associated search ring architecture are shown that are analyzed by the signal transmission optimization system. Specifically, FIG. 2 shows coverage region 1, coverage region 2, coverage region 3, coverage region 4, coverage region 5, coverage region 6, and coverage region 7. In the embodiment shown in FIG. 2, each coverage region is formed by three existing cellular sites. Such as three-sided coverage region may be referred to as a triangle of interest, i.e., a polygonal shaped area formed between potential and/or actual cell towers/sites. In other embodiments, these coverage regions are shaped as other polygons (e.g., hexagons) that formed from more than three of the closest existed cellular towers. Additionally, each coverage region is uniquely identified. The signal transmission optimization data sets within each coverage region are analyzed for ranking by the system. In FIG. 2, coverage region 1 is an on-air cellular site (launch category). Coverage region 3 includes a search ring of a new cellular site. The search ring is around the centroid of the coverage region, which is the equidistant point within the coverage region between the three (or more) sites.

In one or more embodiments, the signal transmission optimization system may be used to optimize the deployment of new cellular sites in coverage regions in a manner that enhances technological advancements, while concurrently improving coverage, capacity, and the quality of signal transmission to the equipment of end users. The signal transmission optimization system analyzes the impact of each cellular site and its location. Additionally, the signal transmission optimization system converts the analysis into numerical metrics that facilitate decision-making.

In some embodiments, the signal transmission optimization system employs a coverage region algorithm that analyzes signal transmission data and prioritizes cellular site deployment to optimize technological impact. Furthermore, the signal transmission optimization system generates a precise assessment of the impact generated by each added cellular site. The signal transmission optimization system divides the geography to be analyzed by potential cellular site deployment into triangles (or other polygons) in vector format for assessment and prioritization. In some embodiments, new cellular sites are located within a coverage region that is formed by three existing cellular sites. In other embodiments, new cellular sites are located within a coverage region that is formed by three (or more) existing cellular sites.

If a coverage region demonstrates high efficiency impact based on technological considerations, such as potential end user population, cellular bandwidth capacity, Points of Interest (POI), and the like, then the coverage region receives a higher priority. This priority is then reflected in the selection of the potential cellular site within that coverage region. If no potential cellular site is identified, a new potential cellular site is proposed with a search ring around a centroid within the coverage region, as shown in FIG. 2.

In some embodiments, the signal transmission optimization system creates a network level grid layout of triangle shapes for potential cellular site deployment for each cellular site and its nearest two neighbors. Each triangle has a unique shape ID and associated technological efficiency impact. In one embodiment, the coverage region grid is created using the Delaunay algorithm. Delaunay triangulation only involves edges between existing points. It does not need a way to represent edges indefinitely in one direction, as required by a Voronoi Diagram. In other embodiments, the signal transmission optimization system creates a network level grid layout of polygonal (e.g., squares, pentagons, hexagons, octagons, etc.) shaped coverage regions for potential cellular site deployment for each cellular site and its nearest neighbors. Each polygon has a unique shape ID and associated technological efficiency impact.

Next, the signal transmission optimization system intersects the coverage region grids with the signal transmission data sets. Otherwise stated, the signal transmission data sets are linked with the coverage region grids with which they correspond. For example, signal capacity data sets are linked with the coverage region grids from which the signal capacity data sets where obtained. Such data sets may include one or more of potential end user store locations, population density, geospatial demographics, failure rate percentage, quality of signal transmission to equipment of the end users, average power received from a single reference signal, signal to noise ratio, and Points of Interest for heavy cellular usage (e.g., malls, hotpots, High Schools, etc.).

Once the signal transmission optimization system has intersected the coverage region grids with the signal transmission data sets, then the system applies the coverage region algorithm to analyze the cellular transmission data sets. Notably, the signal transmission optimization system the converts the analysis into numerical metrics that facilitate decision-making computations.

After the signal transmission optimization system analyzes the technological impacts on the geographical area of the prioritized plurality of coverage region grids, the system then filters the plurality of coverage region grids based on criteria set for each category. For example, in one non-limiting embodiment of the signal transmission optimization system, for a site to be selected the site must have a population density of more than 2000 users, and the drop rate must be more than 3%. In another non-limiting embodiment of the signal transmission optimization system, for a site to be selected the site must have a capacity analysis of XYZ, and the customer experience drop rate must be more than X %. After such a filtering process takes place, the remaining site are then prioritized, as further described below.

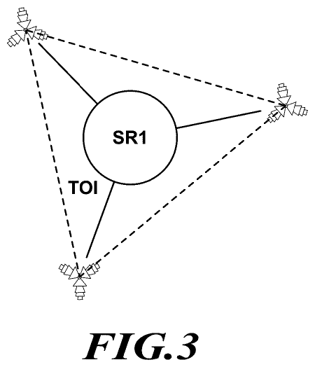

Continuing, the signal transmission optimization system prioritizes the highest ranked coverage region grids for cellular site deployment, and creates a search ring within a centroid inside the coverage region. In this manner, the interest signal transmission optimization system ranks the existing sites based on their technological improvement to the cellular network. Alternatively, if there is no site planned within a highly ranked coverage region, then a new cellular site is proposed around a centroid of the coverage region. FIG. 3 shows a proposed new cellular site within a centroid of the coverage region.

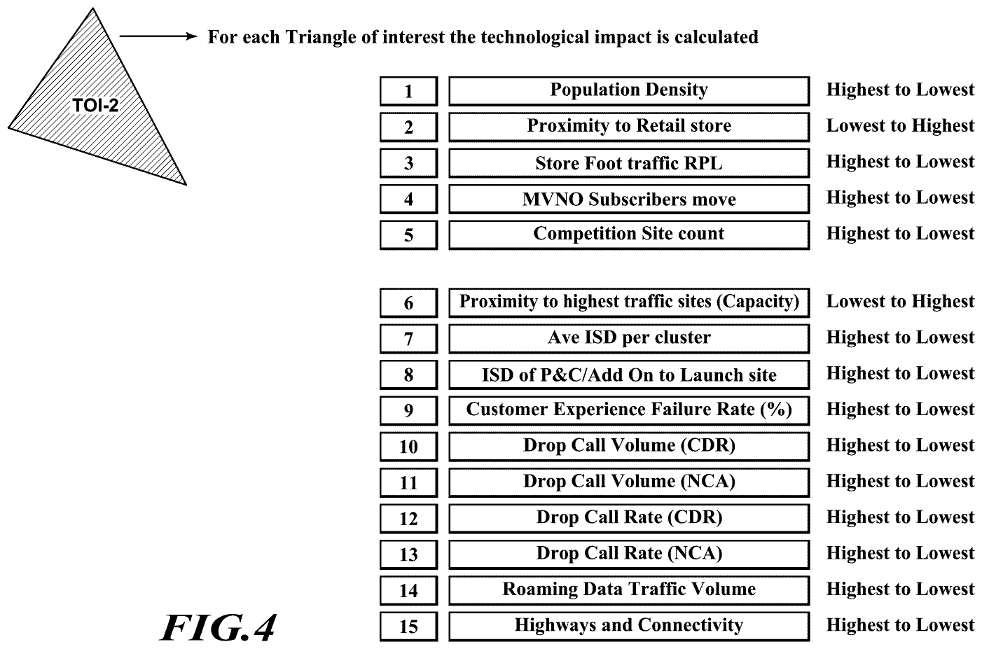

Referring now to FIG. 4, for each coverage region the technological improvement to the cellular network is calculated by the signal transmission optimization system. Specifically, the signal transmission optimization system enables the technological objectives of each coverage region to be customized and ranked as appropriate. Such ranking objectives may include two or more of proximity to highest traffic sites, average Inter-Site Distance (ISD) per cluster, ISD of site/add on to launch site, customer experience drop percentage, drop call volume, and drop call rate, roaming data traffic volume, highways and connectivity, population density, proximity to store, store foot traffic RPL, Mobile Virtual Network Operators (MVNO) subscribes, and competition site count. For example, in the configuration shown in FIG. 4, the population density is the highest ranked objective, the proximity to a store is the second highest ranked objective, the store foot traffic is the third highest ranked objective, and the like. However, in another embodiment (not shown), a user of the signal transmission optimization system has customized and re-ranked the technological objective such that Average Inter-Site Distance per cluster is the highest ranked objective, the customer experience drop percentage is the second highest objective, the capacity is the third highest objective, and the like. The different customize rankings of the technological objectives will affect which location is identified for the next cellular site to be deployed.

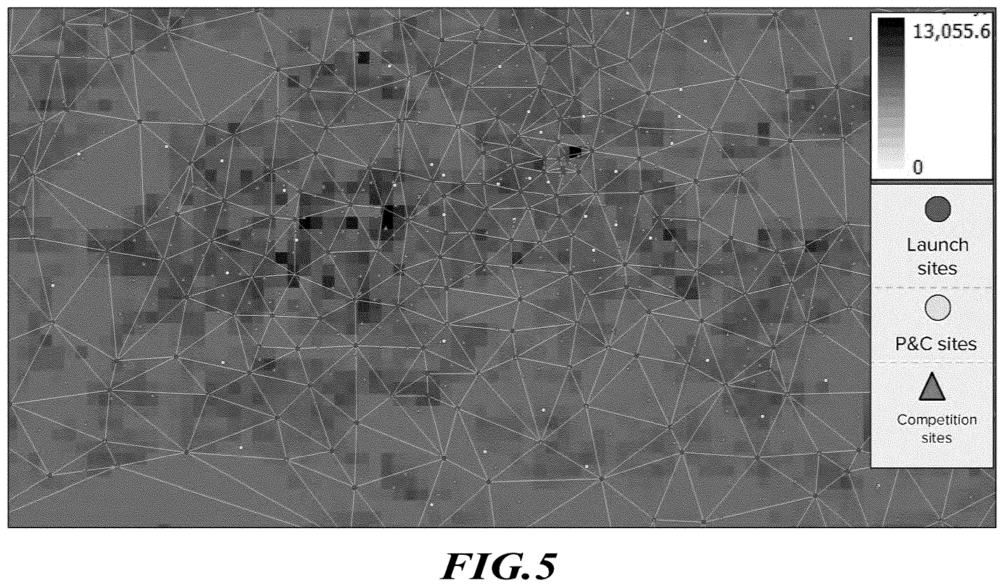

Once these technological objectives have been ranked for each coverage region, the signal transmission optimization system analyzes the technological enhancement on the geographical area of the prioritization of the coverage region grids. Additionally, the signal transmission optimization system assesses the technological enhancement of each deployed cellular site from the plurality of coverage region grids. Examples of the data included in these technological objectives are displayed in FIGS. 5-10.

Referring now to FIG. 5, a population density priority analysis using coverage regions is shown. In some embodiments, these coverage regions are shaped as triangles formed from the three closest existed cellular towers. The population density priority analysis is a useful technological objective since larger population densities likely relate to larger cellular signal end user densities. Thus, larger population densities are likely to put a greater strain on the cellular network, which could be technologically mitigated by the addition of more cellular sites. In FIG. 5, the red circles represent launch cellular sites and the yellow circles represent potential cellular sites for deployment. In some embodiments, the yellow circles are positioned in the search ring of a coverage region, as described above with respect to FIGS. 2 and 3. The green triangles represent competitor sites.

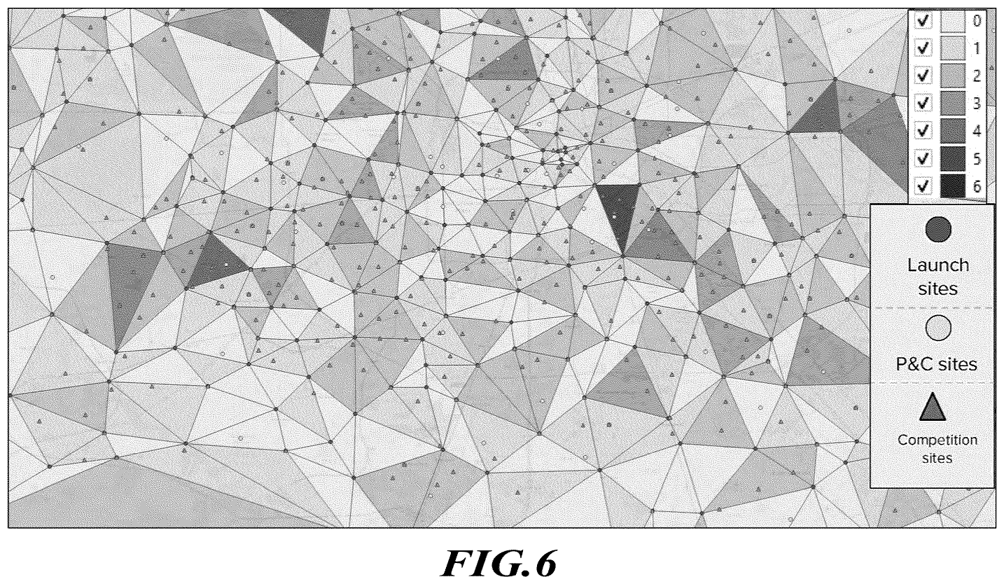

Referring now to FIG. 6, a competition priority analysis using coverage regions and the number of competitor's sites is shown for the same geographical area. This competition priority analysis is a useful technological objective since the home mobile network's technical performance is most likely to be compared to competitor's cellular network in the same geographical region. Thus, the technical performance of a home mobile network will likely want to be equivalent or superior to that of the competitor's cellular network in the same geographical region. As shown in FIG. 6, the darker the triangle, the more competitor's cellular sites are deployed in that region (and likely the more robust the competitor's cellular network is in that region). In FIG. 6, the red circles represent launch cellular sites and the yellow circles represent potential cellular sites. The green triangles represent competitor sites.

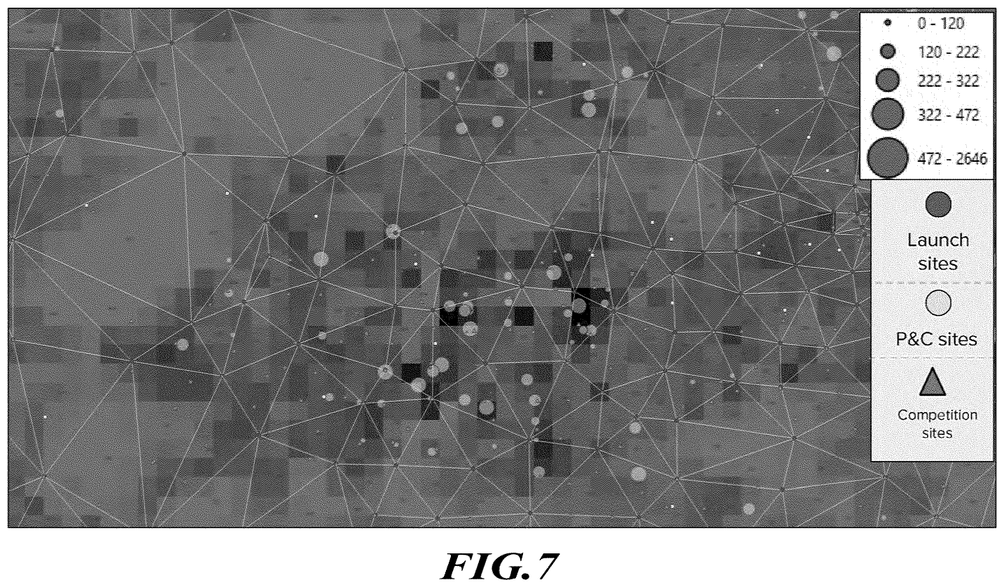

Referring now to FIG. 7, a traffic per store priority analysis using triangles of interest is shown. As used herein, “traffic” refers to the number of end users with cellular equipment (i.e., UEs) per home store that is providing customer support, such as activation of the cellular equipment of the end users. This traffic per store priority analysis is a useful technological objective since larger numbers of cellular end users per store likely relate to larger cellular signal end user densities. Thus, larger traffic per store densities are likely to put a greater strain on the cellular network, which could be technologically mitigated by the addition of more cellular sites. In FIG. 7, a small magenta circle represents 0-120 cellular end users per store, a slightly larger magenta circle represents 120-222 cellular end users per store, a still larger magenta circle represents 222-322 cellular end users per store, a second to largest magenta circle represents 322-472 cellular end users per store, and the largest magenta circle represents 472-2646 cellular end users per store. Thus, it is technologically beneficial to deploy new cellular sites near the largest traffic per store densities. Additionally, the red circles represent launch cellular sites and the yellow circles represent potential cellular sites. The green triangles represent competitor sites.

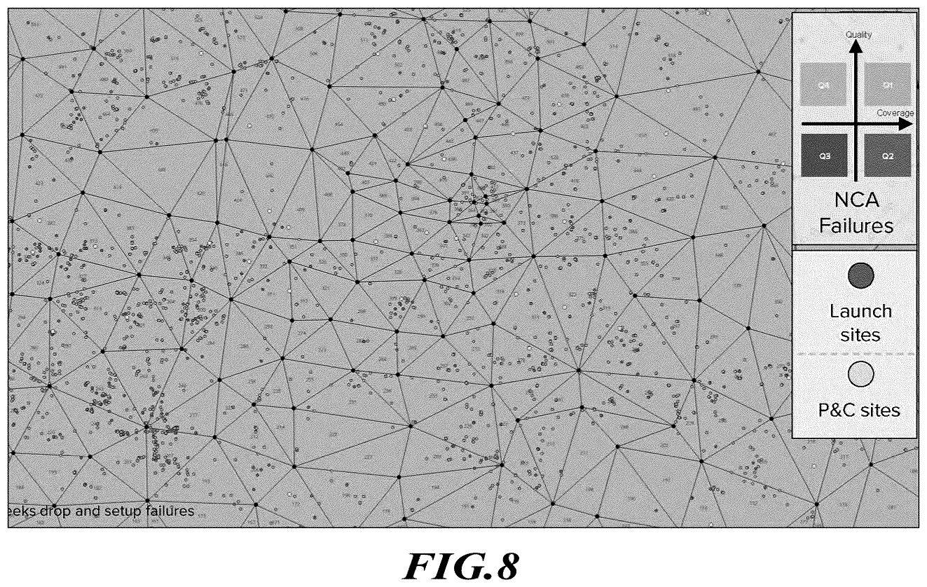

Referring now to FIG. 8, a customer drop call (i.e., overall call drop percentage) priority analysis using triangles of interest is shown. This customer drop call analysis is a useful technological objective since overall call drop percentage likely relates to lower network technical capacity and/or efficiency. Thus, higher overall call drop percentage likely represents greater strained regions of the cellular network, which could be technologically mitigated by the addition of more cellular sites to that region. In FIG. 8, signal failures are represented by four quadrants (i.e., Q1, Q2, Q3, and Q4), on a graph of signal coverage on the X-axis and signal quality on the Y-axis. Q1 (which represents high signal quality and high signal coverage) is shown in green, Q2 (which represents low signal quality and high signal coverage) is shown in blue, Q3 (which represents low signal quality and low signal coverage) is shown in red, and Q4 (which represents high signal quality and low signal coverage) is shown in orange. Thus, it is technologically beneficial to deploy new cellular sites near the largest overall call drop densities. Additionally, the red circles represent launch cellular sites and the yellow circles represent potential cellular sites.

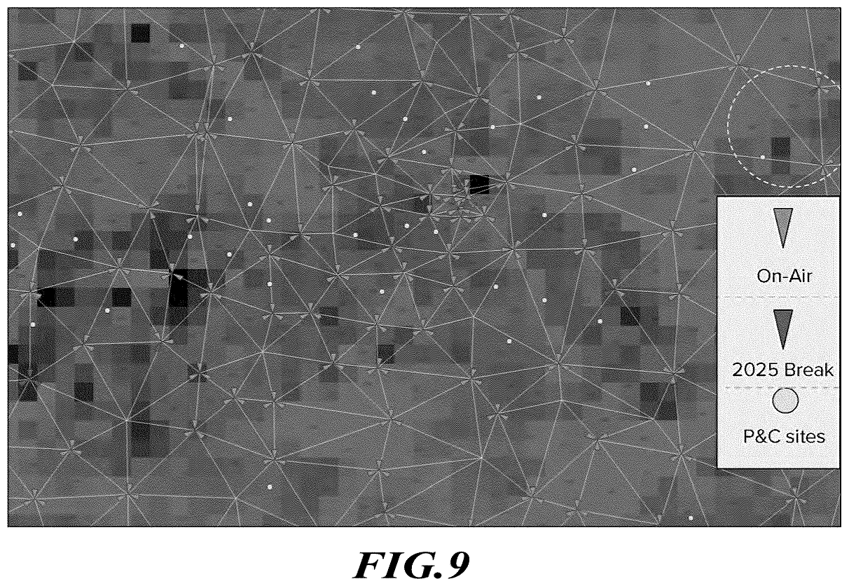

Referring now to FIG. 9, a capacity break analysis using coverage regions is shown. Specifically, the capacity break analysis identifies sectors that are predicted to break capacity limits. This capacity break analysis is a useful technological objective since sectors that are predicted to break capacity limits likely relate to lower network technical efficiency. Thus, higher capacity readings likely represent greater strained regions of the cellular network, which could be technologically mitigated by the addition of more cellular sites to that region. Therefore, it is technologically beneficial to deploy new cellular sites near the largest capacity densities. Additionally, the green triangles represent on-air cellular sites, red triangles represent 2025 break cellular sites, and the yellow circles represent potential cellular sites.

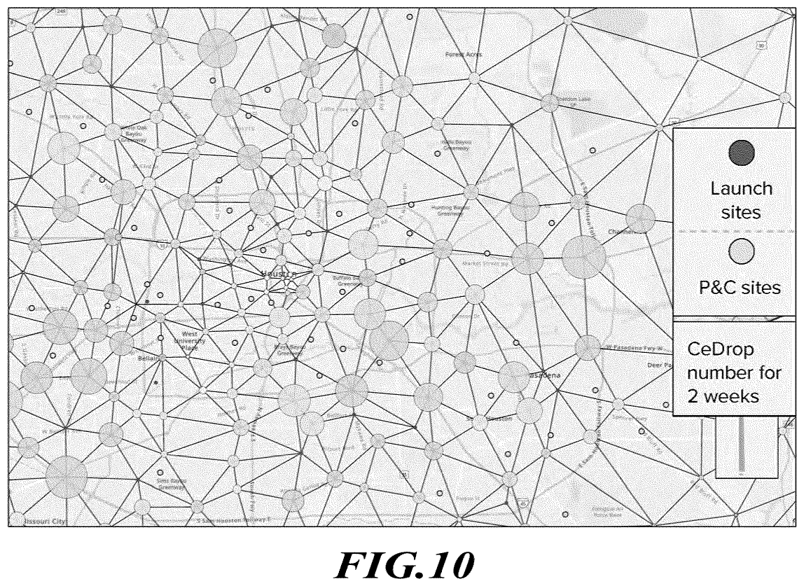

Referring now to FIG. 10 a customer experience drop rate percentage analysis using coverage regions is illustrated. Specifically, the customer experience drop rate percentage analysis identifies otherwise normal calls with high mute time and/or severely degraded voice quality in the last interval before the end of the call. In some embodiments, the customer experience drop rate criteria include (1) normal release cause, (2) last interval mute time greater than 10 seconds, and (3) last interval UL MOS (Voice Quality Score) less than 1.5. This customer experience drop rate analysis is a useful technological objective since sectors that experience higher customer experience drop rates likely relate to lower network technical efficiency. Thus, higher customer experience drop rates likely represent greater strained regions of the cellular network, which could be technologically mitigated by the addition of more cellular sites to that region. Therefore, it is technologically beneficial to deploy new cellular sites near the largest customer experience drop rate densities. Additionally, the red circles represent launch cellular sites and the yellow circles represent potential cellular sites.

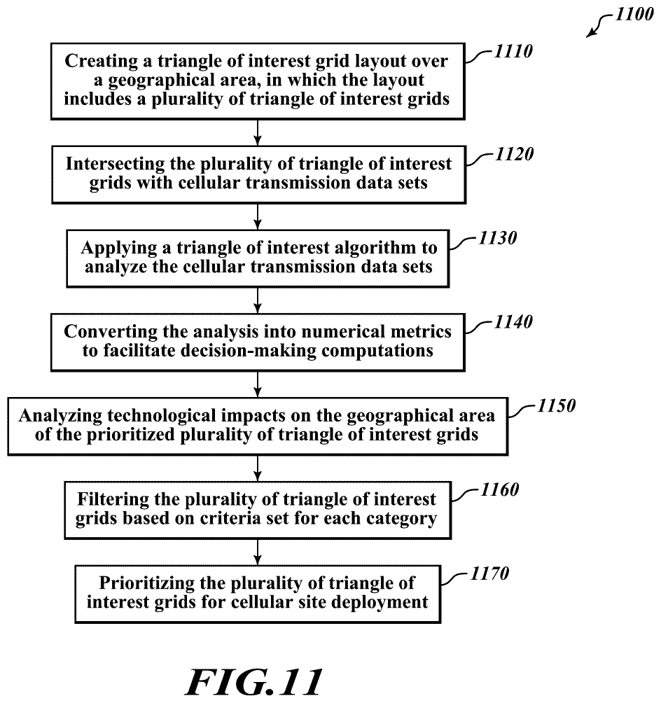

FIG. 11 a logic diagram showing a system for determining signal transmission optimization of coverage regions in new service areas. As shown in FIG. 11, at operation 1110, the method includes creating a grid layout over a geographical area of coverage regions, in which the layout includes a plurality of coverage region grids. At operation 1120, the method includes intersecting the plurality of coverage region grids with cellular transmission data sets. At optional operation 1130, the method includes applying a coverage region algorithm to analyze the cellular transmission data sets. At operation 1140, the method includes converting the analysis into numerical metrics to facilitate decision-making computations. At operation 1150, the method includes analyzing technological impacts on the geographical area of the prioritized plurality of coverage region grids. At operation 1160, the method includes filtering the plurality of coverage region grids based on criteria set for each category. At operation 1170, the method includes prioritizing the plurality of coverage region grids for cellular site deployment.

In some embodiments, end user mobile devices have experienced dropped calls or other network problems such as poor service. In some embodiments, the disclosed system consolidates user data (or tester data) regarding dropped calls of end user mobile devices and other network problems. This user data (or tester data) may include data logs, as well as service calls, user/tester complaints, or other data that has been generated or obtained by the carrier network. In some embodiments, this user/tester data will be collected over as long a period of time as possible. In other embodiments, such as when a recent network upgrade has occurred, the user/tester data may be collected and consolidated from the time and date of the upgrade to present.

Referring now to other aspects of the system for determining signal transmission optimization of coverage regions, in some embodiments, this consolidated user data is then used as training data to train a machine learning model regarding dropped calls of the end user mobile devices and/or other network problems experienced by the end user. Next, the machine learning model analyzes the user data to determine geographical areas in which repetitive dropped calls of the end user mobile devices and/or other network problems experienced by the end user have been identified. This analysis of the training data by the machine learning model is then able to predict, as an output from the machine learning model, future dropped calls of the end user mobile devices and/or other network problems experienced by the end user in identified geographical areas. This analysis may be added to the grid prioritization for coverage regions.

Embodiments of the system and method for determining signal transmission optimization of coverage regions have been described above that implement a machine learning model. While many embodiments of the system and method for determining signal transmission optimization of coverage regions implement a machine learning model, other embodiments of the system and method for determining signal transmission optimization of coverage regions do not employ a machine learning model, but rather utilize more traditional analysis (i.e., non-machine learning). There may be several technical reasons to implement traditional, non-machine learning, analysis, including by way of example only, and not by way of limitation: lack of sufficient computation power available, an insufficient amount of data to properly train a machine learning model, lack of authorization to use the data in a machine learning model (e.g., potentially due to contractual or privacy issues), or the like. Thus, the poor signal coverage regions may be identified using other types of analysis (i.e., non-machine learning) of the signal optimization data in one or more embodiments of the system and method for determining signal transmission optimization of coverage regions.

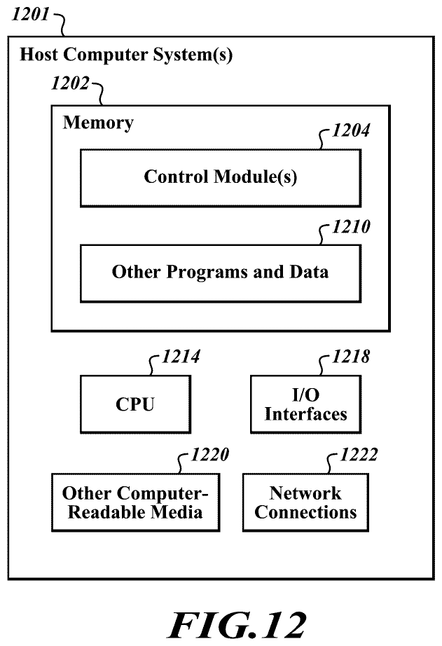

FIG. 12 shows a system diagram that describes an example implementation of a computing system(s) for implementing embodiments described herein. The functionality described herein for a system for determining signal transmission optimization of coverage regions, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility.

In particular, shown is example host computer system(s) 1201. For example, such computer system(s) 1201 may represent those in various data centers and cell sites shown and/or described herein that host the functions, components, microservices and other aspects described herein to implement a system for determining signal transmission optimization of coverage regions. In some embodiments, one or more special-purpose computing systems may be used to implement the functionality described herein. Accordingly, various embodiments described herein may be implemented in software, hardware, firmware, or in some combination thereof. Host computer system(s) 1201 may include memory 1202, one or more central processing units (CPUs) 1214, I/O interfaces 1218, other computer-readable media 1220, and network connections 1222.

Memory 1202 may include one or more various types of non-volatile and/or volatile storage technologies. Examples of memory 1202 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 1202 may be utilized to store information, including computer-readable instructions that are utilized by CPU 1214 to perform actions, including those of embodiments described herein.

Memory 1202 may have stored thereon control module(s) 1204. The control module(s) 1204 may be configured to implement and/or perform some or all of the functions of the systems, components and modules described herein for a system for determining signal transmission optimization of coverage regions. Memory 1202 may also store other programs and data 1210, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 1222 are configured to communicate with other computing devices to facilitate the functionality described herein. In various embodiments, the network connections 1222 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1218 may include a video interface, other data input or output interfaces, or the like. Other computer-readable media 1220 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for determining signal transmission optimization of coverage regions, the method comprising:
creating a grid layout over a geographical area of coverage regions, the layout including a plurality of coverage region grids for potential cellular site deployment;
intersecting the plurality of coverage region grids with cellular transmission data sets;
applying a coverage region algorithm to analyze the cellular transmission data sets;
converting the analysis into numerical metrics;
analyzing technological impacts on the geographical area of the plurality of coverage region grids based on the numerical metrics;
filtering the plurality of coverage region grids based on criteria set for each category; and
prioritizing the plurality of coverage region grids for cellular site deployment.

2. The method of claim 1, wherein the coverage region algorithm divides the geography into triangles in vector format for assessment and prioritization.

3. The method of claim 1, wherein new sites are located within a triangle formed by three existing sites.

4. The method of claim 1, wherein each coverage region is uniquely identified, and the data sets within the coverage region are analyzed for ranking.

5. The method of claim 1, wherein one or more factors that affect the technological impact include population, stores, capacity, or Points of Interest (POI), the coverage region receives higher priority.

6. The method of claim 1, further comprising:
creating a search ring within a coverage region centroid of the highest priority grid within the plurality of coverage region grids.

7. The method of claim 6, further comprising:
proposing a new cellular site location for deployment within the search ring from the technological impacts on the geographical area.

8. The method of claim 1, wherein the cellular transmission data sets include one or more of population density, capacity data, proximity to highest traffic sites, average Inter-site distance (ISD) per cluster, ISD of site/Add On to Launch site, customer experience drop percentage, Drop Call Volume, and Drop Call Rate.

9. A system for determining signal transmission optimization of coverage regions, the system comprising:
a memory that stores computer-executable instructions; and
a processor that executes the computer-executable instructions that cause the processor to:
create a grid layout over a geographical area of coverage regions, the layout including a plurality of coverage region grids for potential cellular site deployment;
intersect the plurality of coverage region grids with cellular transmission data sets;
apply a coverage region algorithm to analyze the cellular transmission data sets;
convert the analysis into numerical metrics;
analyze technological impacts on the geographical area of the plurality of coverage region grids based on the numerical metrics;
filtering the plurality of coverage region grids based on criteria set for each category; and
prioritize the plurality of coverage region grids for cellular site deployment.

10. The system of claim 9, wherein the coverage region algorithm divides the geography into triangles in vector format for assessment and prioritization.

11. The system of claim 9, wherein each coverage region is uniquely identified and the data sets within the coverage region are analyzed for ranking.

12. The system of claim 9, wherein one or more factors that affect the technological impact include population, stores, capacity, or Points of Interest (POI), the coverage region receives higher priority.

13. The system of claim 9, wherein a search ring is created within a coverage region centroid of the highest priority grid within the plurality of coverage region grids.

14. The system of claim 13, wherein a new cellular site location for deployment within the search ring from the technological impacts on the geographical area.

15. The system of claim 9, wherein the cellular transmission data sets include one or more of population density, capacity data, proximity to highest traffic sites, average Inter-site distance (ISD) per cluster, ISD of site/Add On to Launch site, customer experience drop percentage, Drop Call Volume, and Drop Call Rate.

16. A method for determining signal transmission optimization of coverage regions, the method comprising:
creating grid layout over a geographical area of coverage regions, the layout including a plurality of coverage region grids for potential cellular site deployment with associated cellular transmission data sets;
applying a coverage region algorithm to analyze the cellular transmission data sets;
analyzing technological impacts on the geographical area of the prioritization of the plurality of coverage region grids;
filtering the plurality of coverage region grids based on criteria set for each category; and
prioritizing the plurality of coverage region grids for cellular site deployment.

17. The method of claim 16, wherein the analysis is converted into numerical metrics.

18. The method of claim 16, wherein the coverage region algorithm divides the geography into triangles in vector format for assessment and prioritization.

19. The method of claim 16, wherein new cellular sites are located within a triangle formed by three existing sites.

20. The method of claim 16, wherein each coverage region is uniquely identified and the data sets within the coverage region are analyzed for ranking.
